(19) United States
(12) Patent Application Publication
(10) Pub. No.: US 2002/0019831 A1
(43) Pub. Date: Feb. 14, 2002

(54) Methods, systems, and presentations for delivery over the internet

(76) Inventor: Wyly Wade, Sarasota, FL (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/766,402

(22) Filed: Jan. 19, 2001

Related U.S. Application Data
(63) Continuation of application No. 60/176,895, filed on Jan. 19, 2000.

(51) Int. Cl. G06F 15/00

(52) U.S. Cl. 707/500

(57) ABSTRACT

A method of presenting involves including common presentation functionality in a presentation engine residing on the user's computer and all presentation-specific functionality in a presentation instructions datafile that is delivered to the user's computer and run by the presentation engine. The instructions datafile and the presentation engine may be adapted so that that the presentation engine can easily input the instructions datafile, run the presentation-specific instructions, and display the resulting presentation.

### RELATED APPLICATIONS

This application claims priority to, and incorporates by reference, co-pending provisional patent application Ser. No. 60/176,895 filed on Jan. 19, 2000, entitled “Methods, Systems, and Presentations for Delivery of the Internet.”

### FIELD OF THE INVENTION

The present invention relates generally to methods, systems, and presentations for delivery over the Internet.

### BACKGROUND OF THE INVENTION

The Internet has been lauded as the Information Highway. The Internet was originally designed to allow for the transfer of information within the military but has since transgressed into the commercial sector of society. In fact, practically every technology company and perhaps most, if not all, of the Fortune 500 companies have some presence on the Internet. Companies are not only providing information on their company, products or services, but are also conducting commerce over the Internet.

The Internet has proven to be a unique opportunity for advertisers marketing their products or services. The Internet is a relatively new medium which reaches a large population of people and which allows for the almost instantaneous delivery of advertisements to the viewing public. Revenues from advertising on the Internet are continuing to increase and will likely increase in the foreseeable future. The Internet Advertising Bureau estimated that in 1998 Internet advertising revenue accounted for 22 percent of total cable television advertising revenues and that during the first quarter of 1999, Internet/on-line advertising revenues totaled $693 million.

A banner ad is the typical way in which advertising is delivered over the Internet. When a user selects a web page, such as by entering the Uniform Resource Locator (“URL”) for a web site or by clicking on a link, the requested page is delivered to the user and within this page are located one or more banner ads. The banner ads cover a fraction of the entire web page with the remaining portion of the page devoted to the requested content. The banner ad may be static such as a GIF file or dynamic such as an animated GIF or a Java applet.

While many advertisements on the Internet are static, the advertisements are preferably dynamic so that some movement is performed within the advertisement. In addition to moving images, advertisers would ideally like to have audio delivered and would like to mimic television commercials. Due to bandwidth limitations, however, delivering multi-media advertisements over the Internet is impractical. The viewer simply would not tolerate the long wait necessary to download the large multi-media files.

The content provider for a web site must balance the amount of content delivered within a web page with the amount of space designated for advertising. A web page contains a limited amount of space or “real estate” on the viewer's computer and the content provider must allocate this real estate between content and advertisements. On the one hand, the content provider wants to satisfy the viewer's request for content and provide as much of that information as possible. On the other hand, the content provider must generate revenue to support the site and has an interest in providing more advertising so as to increase revenue. The content provider therefore has to achieve an optimal balance between advertising and content.

Because advertisements are delivered along with the content, a viewer must wait for the entire page to be delivered before all of the advertisement and content can be reviewed. The advertisements are frequently located at the top of a page as well as along either side and the bottom of a page. While the top, sides and bottom are the common locations for advertisements, advertisements can really be placed at any location on a page and may be delivered in any order with the content. For instance, the content may be delivered first and have blank spaces which are subsequently filled with the advertisements. Alternatively, some or all of the advertisements may be delivered first followed by the requested content.

As discussed above, the Internet is heavily supported by advertising. The exact price advertisers pay for their advertisements is dependent upon a variety of factors, such as the size and placement of the advertisement, the site and location within the site upon which the advertisement appears, and the number of hits to that particular site. Since the cost to the advertiser varies with the number of hits to the site, some measure of the amount of traffic that a site receives must be captured. This measure may be literally the number of hits at a particular site having the advertisement of interest or may be based on other parameters that are related to traffic to the site. Further, the measure may be observed at the web server, at a separate ad server, or based on observations at both the web and ad servers. Regardless of precisely how this measure is captured, advertising rates are based in some way on the traffic at a particular site.

For various reasons, some of which are described below, a viewer may not receive or even see some of the advertisements associated with a web page. For instance, the advertisement may never be delivered to the user due to the user stopping download of the page or clicking through to a next page. The advertisement may be delivered to the user, but the advertisement may not be seen due to the user scrolling down the page before the advertisement is inserted into its designated space. As another possibility, the advertisement may be delivered to the viewer and inserted within view but the viewer misses the advertisement due to the viewer focusing on the content on the page. In all these situations, the advertisers often still have to pay the web site even though the viewer never saw the advertisement.

In addition to not being seen, another challenge with advertising over the Internet is to deliver advertising to the ideal segment of the Internet audience. Initially, advertising was broadcast to the viewing audience without regard to the identity or viewing preferences of the individual viewer. In other words, a requested web page would have a certain advertisement or set of advertisements and these advertisements would be transmitted in the web page with every request. With the advent of cookies, a mechanism used by web servers to store and access user information on the user's computer, advertising over the Internet has become more intelligent. Advertisers can use the information stored within cookies, such as user identification and preferences, to select and insert different advertisements into a page requested by the particular user. In this manner, the viewers would receive advertisements that are more suited to their own interests.

U.S. Pat No. 5,948,061 to Merriman et al. (“Merriman”) discloses an even more sophisticated method of targeting advertisements to the viewer. According to one embodiment in Merriman, after a user sends a request to a web site, the web site responds by providing all of the requested information to the user except for the banner advertisements. The web site does not transmit the banner advertisement but instead transmits back a link to the user's computer which includes an IP address from which the advertisements will be obtained. The user's computer transmits to the advertisement server a message which includes the user's IP address, a cookie, an indication of the page in which the advertisement is to be inserted, and information indicating the type and version of the user's browser. From the information transmitted from the user's computer, the advertisement server identifies the user and determines which advertisement object should be selected. The selected advertisement object is transmitted to the user and displayed along with the information from the web site. If the user then clicks on the advertisement, the advertisement server redirects the user's computer to the URL for the advertiser's web site based on data stored at the advertisement server.

The advertisement server maintains a database for targeting advertisements, measuring advertising, and directing users to desired advertiser's web sites. For instance, the advertisement server keeps information on each user it encounters so that an advertisement can be selected to match a user's profile. In selecting an advertisement, the advertisement server also considers a satisfaction index which is calculated using the number of times a particular advertisement has been viewed by anyone, the number of times that the advertisement should be viewed by anyone, the number of days the advertisement is scheduled to run, and the number of days that the advertisement has run to date. The advertisement server generates reports about the success rate of an advertisement, statistics on users, and how often advertisements are being displayed.

Despite the ability to target advertisements to particular viewers and to track various aspects of Internet advertising, existing systems such as the one described in Merriman still suffer from some of the same basic limitations in Internet advertising as less sophisticated systems and methods. The viewers requesting web pages from a site may not receive the advertising due to the user clicking through to a next page or stopping the download. Also, the advertising may be delivered to the viewer but the viewer may not take notice of the advertisement. A need therefore exists for improved systems and methods for Internet advertising, such as ones that are better able to measure the effectiveness of advertisements.

As discussed above, viewers commonly stop a download or click through to the next site before receiving the entire download. A major cause for the frequent stopping of downloads is the slow transfer speeds viewers experience; the Public Switched Telephone Network (PSTN), the Internet Service Providers (ISPs), and the Internet do not have sufficient bandwidth to meet consumer demand for higher speed access. Viewers have a limited amount of patience when it comes to waiting for a download to complete and often are not willing to wait the long period of time for a download and instead move on to the next page. This behavior of viewers not only prevents advertisers from allowing the advertisements to reach the viewers but also prevents the hosting web server from providing content to viewers. A need therefore exists for eliminating the long period of time in which the viewer's computer is inactive and waiting for the next web page.

U.S. Pat. No. 5,737,619 to Judson (“Judson”) describes one attempt at filling in the “gap” between the time that a user requests a web page and the time that the web page has completely downloaded to the user's computer. According to Judson, an information object, which may comprise an advertisement, is appended to, or embedded within, a web page that is delivered to a viewer. The viewer does not initially see the advertisement but instead can browse through the downloaded web page. When the viewer directs the browser to another page or to another site, the advertisement is activated and is displayed to the viewer. The advertisement can be displayed in a “mini-page,” such as a pop-up window. Judson explains in column 8, that applets are downloaded to the viewer's computer and are cached or otherwise stored. An engine associated with the browser then executes the downloaded applets when a new link is established.

With Judson, the information objects would often not be seen by the viewer. The viewer first needs to download a web page that has an associated object. If the viewer stops the download of the web page or thereafter stops the download of the object, the information object would not be displayed at the viewer's computer. Further, even if the object is downloaded, the viewer must perform some additional action before the object is displayed. As described in Judson, the object may be displayed after the viewer clicks to another page or selects a new site. Moreover, the advertisements are cached or otherwise stored at the viewer's computer. Many computers, unfortunately, are unable to cache the advertisements whereby these computers would not be able to see any of the advertisements. For instance, Windows NT operating systems and Macintosh would likely not be able to cache advertisements downloaded in a manner described by Judson.

Another disadvantage of Judson is that the information object is displayed in a “mini” web page. A pop-up window, which can be considered as a “mini” web page, often occurs when a web page or a link is selected. These pop-up windows frequently display advertisements and can be annoying to users. Rather than seeing the requested page, the viewer's computer displays some of the page, or at least part of the previous page, and also displays the pop-up window. These pop-up windows often distract the viewer from the desired web page and do not present the most effective way of capturing the attention of the viewer. In a similar way, the “mini” web page described by Judson can be considered a distraction since the attention of the viewer may be focused on the remaining portion of the browser, namely the requested page or the previously viewed page.

Another disadvantage of existing methods of delivering advertisements over the Internet is that the advertisements take a relatively long time to download. As more and more features and effects are added to advertisements, the data payload for the advertisements increases even more, thereby further lengthening the time or the amount of bandwidth needed to transmit the advertisements. A need therefore exists for systems and methods for reducing the amount of time or the bandwidth necessary to deliver advertisements over the Internet.

### SUMMARY OF THE INVENTION

The present invention addresses the problems described above by providing methods, systems, and presentations for delivery over the Internet. According to one aspect of the invention, the presentation includes an initial download that can be quickly delivered to the user's node through a computer network, which is preferably the Internet. The initial download is structured so that it can be quickly delivered through the Internet and, in one embodiment, comprises text that can be quickly displayed on the user's computer. The presentation also includes subsequent downloads that are transmitted through the Internet to the user's node for completing the presentation. The presentation is preferably a multi-media presentation which includes any combination of text, graphics, and audio. Along with the initial download and the subsequent download, a delivery verification command is also transmitted to the user's computer. The delivery verification command causes the user node to transmit a verification signal thereby indicating that the presentation has been delivered to the user's computer.

The presentation preferably comprises an advertisement that is delivered to the user's computer. As discussed above, conventional techniques for providing advertising over the Internet suffer from an inability to accurately measure the extent to which advertisements are delivered to users and are seen by the users. By transmitting a delivery verification command with the presentation, the verification signals can be tracked to allow an accurate measure of which advertisements were actually delivered to the user's computer.

According to another aspect, the invention relates to a presentation which is transmitted in a plurality of segments but which appear as a single continuous presentation at the user's computer. According to this aspect, the presentation includes an initial download that is quickly delivered to the user's node and can therefore be promptly displayed at the user's computer. This subsequent download is followed by one or more subsequent downloads which are used at the user's computer to complete the presentation. From the user's perspective, the presentation is promptly started and continues to the end without interruption. The user is preferably unaware that the entire presentation was transmitted in a plurality of segments.

According to a further aspect of the invention, advertisements may be delivered by including all common advertisement presentation functionality in an advertisement presentation engine residing on the user's computer and all advertisement-specific functionality in an advertisement instructions datafile that is delivered to the user's computer and run by the presentation engine. The advertisement instruction datafile and the advertisement presentation engine may be adapted so that that the presentation engine can easily input the instructions datafile, run the advertisement-specific instructions, and display the resulting advertisement.

### BRIEF DESCRIPTION OF THE DRAWINGS

The accompanying drawings, which are incorporated in and form a part of the specification, illustrate preferred embodiments of the present invention and, together with the description, disclose the principles of the invention. In the drawings:

FIG. 1 is a block diagram of a network according to a preferred embodiment of the invention;

FIG. 2 is a flow chart of a preferred method of delivering advertisements over the network of FIG. 1;

FIG. 3 is a flow chart of a preferred method performed by the user node of FIG. 1;

FIG. 4 is a flow chart of a preferred method performed by the host server of FIG. 1;

FIG. 5 is a flow chart of a preferred method performed by the advertisement server of FIG. 1;

FIG. 6 is a flow chart of a preferred method performed by the advertiser server of FIG. 1;

FIG. 7 is a block diagram of the network of FIG. 1 showing in more detail the advertisement server;

FIGS. 8(a) and 8(b) are flowcharts of preferred methods of transmitting advertisements from the host server and receiving advertisements at the user node, respectively;

FIG. 9 is an exemplary diagram of an advertisement according to the preferred embodiment of the invention;

FIG. 10 is an exemplary listing for building the index page element of FIG. 9;

FIG. 11 is an exemplary listing for building the splash screen page element of FIG. 9;

FIG. 12 is an exemplary listing of the JVM applet of FIG. 9;

FIG. 13 is an exemplary listing for building the index frame page element of FIG. 9;

FIG. 14 is an exemplary listing for building the bottom page element of FIG. 9;

FIG. 15 is an exemplary listing for building the main page element of FIG. 9;

FIG. 16 is an exemplary listing for building the second main page element of FIG. 9;

FIGS. 17a to 17d provide an exemplary listing of Java script for the Java class file of FIG. 9;

FIGS. 18a to 18c provide an exemplary listing of Java script for the Java class file of FIG. 9;

FIG. 19 is an exemplary listing of Java script for the Java class file of FIG. 9;

FIGS. 20a to 20e show an exemplary listing of the delivery verification applet of FIG. 9;

FIG. 21 is a flowchart of an alternative method of delivering advertisements over the network of FIG. 1 by the user node;

FIG. 22 is a flowchart of an alternative method of delivering advertisements over the network of FIG. 1 by the host server;

FIG. 23 is a flowchart of an alternative method of delivering advertisements over the network of FIG. 1 by the advertisement server;

FIGS. 24a and 24b are time-line diagrams illustrating operation of a universal applet according to a preferred embodiment of the invention; and

FIG. 25 is a system diagram illustrating operation of the universal applet of FIGS. 24a and 24b.

### DETAILED DESCRIPTION

Reference will now be made in detail to preferred embodiments of the invention, non-limiting examples of which are illustrated in the accompanying drawings.

I. Overview

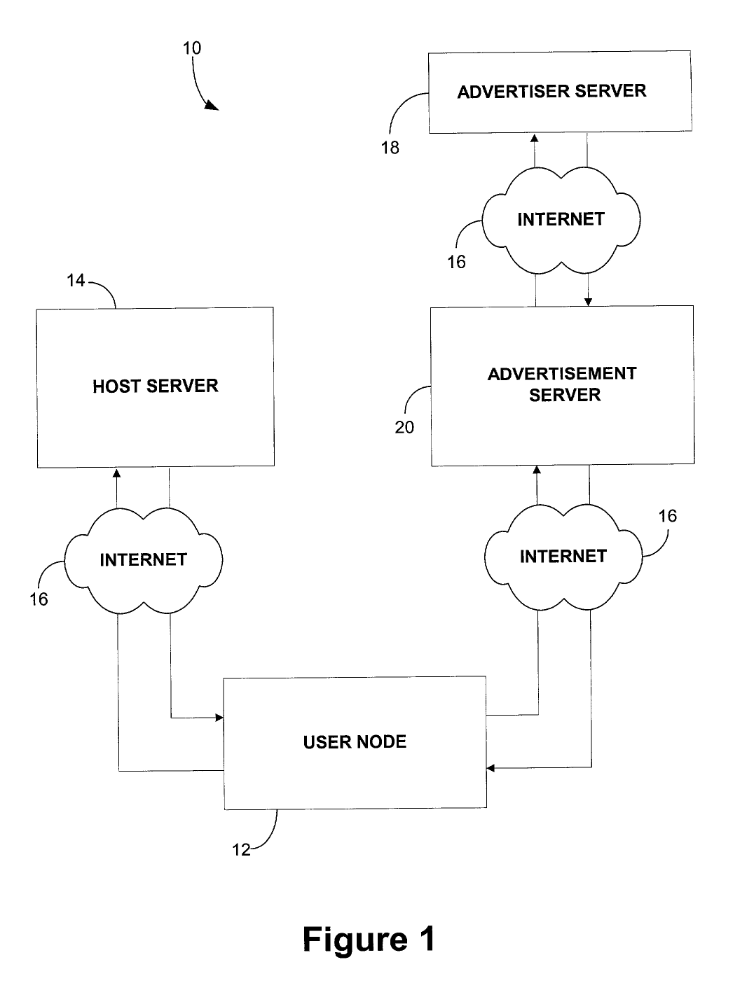

With reference to FIG. 1, a network according to a preferred embodiment of the invention includes a user node 12, a host server 14, an advertiser server 18, and an advertisement server 20. The user node 12 may be any device which allows a user to access information from the Internet 16. Frequently, the user node 12 is a personal computer which accesses the Internet 16 through an Internet Service Provider (ISP). The user node 12 may alternatively access the Internet 16 through a Wide Area Network (WAN) or a Local Area Network (LAN). The user node 12 may access the Internet 16 through any appropriate intermediate network, such as the Public Switched Telephone Network (PSTN), a Digital Subscriber Line (DSL), a data network, a cellular or radio mobile telephone network, a paging network, a cable network, and/or a satellite link. The user node 12 is not limited to a personal computer, but, as should be apparent from the various types of networks for accessing the Internet 16, may comprise any device, such as a Personal Data Assistant (PDA), a pager, a mobile radio telephone, a television, or a vehicle.

The host server 14 provides information to the user node 12 with this information typically, although not necessarily, comprising web pages. The information that is available at the host server 14, of course, varies with the particular host server 14. The information, for instance, may be directed toward products, services, entertainment, government, or financial, educational, business, health or legal information. Typically, a domain name for the host server 14 is entered at the user node which directs a browser resident on the user node 12 to the host server 14. The user node 12 may be directed toward the host server 14 directly by entering the domain name or IP address, as discussed above, or alternatively the user node 12 may be directed toward the host server 14 by a hyperlink or by routing that occurs at another host server.

As will be apparent from the description below, a network according to the invention need not contain the advertisement server 20 or the advertiser server 18. In the preferred embodiment, however, the network 10 also includes the advertisement server 20 which provides advertisements to the user node 12. Conventionally, as described in U.S. Pat. No. 5,948,061 to Merriman et al., which is hereby incorporated by reference, a hosting web site would provide some information and an advertising server process would insert banner ads into the requested information. The hosting web site therefore provides a partial download to the user's browser and directs the user's browser to the advertising server process for the banner ads. The advertisement server 20 according to the preferred network 10 may also provide banner ads which are to be inserted within content provided by the host server 14. Preferably, the advertisement server 20 provides advertising in a manner different than banner ads, with these differences being explained in full detail below.

The advertisement server 20 and the advertiser server 18 are shown in FIG. 1 as being separate from the host server 14. It should be understood that the advertisement server 20 may be co-located or may reside on the host server 14 whereby both information related to the host server and the advertisements are delivered by the same server. Similarly, the advertiser server 18 is shown as being separate from the advertisement server 20 and the host server 14. The advertiser server 18 and the advertisement server 20 may reside on the same server or be co-located or the advertiser server 18 may reside or be co-located with the host server 14. The locations and separations between the host server 14, the advertiser server 18, and the advertisement server 20 are therefore not limited in the way that they are illustrated in FIG. 1.

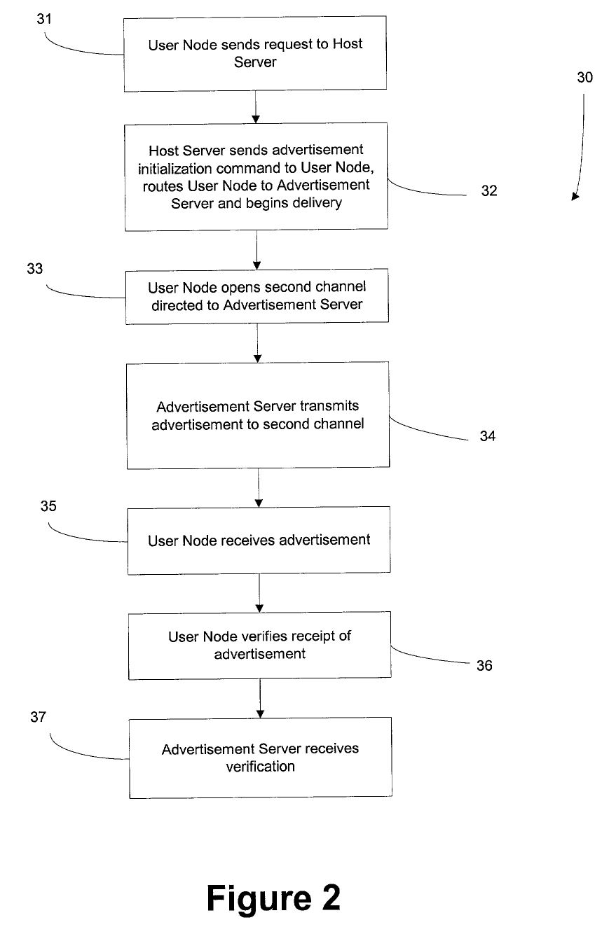

The invention will be described with reference to providing advertising over the Internet. The information that is provided by the advertisement server 20, however, need not be limited to an advertisement per se but encompasses any type of information. As with the host server 14, this information is limitless, and includes, but is not limited to sports, financial, polling, government-related services, or news. To distinguish the information that is provided by the host server 14 and the information that is provided by the advertisement server 20, the information provided by the host server 14 will be referred throughout this document as content while the information provided by the advertisement server 20 will be referred to as an advertisement. Again, while this terminology simplifies the description of the invention, the user of these terms should not limit the delivery of information from the advertisement server 20 to just advertisements. With reference to FIG. 2, a preferred method 30 of delivering advertisements over the network 10 will now be described. At 31, the user node 12 sends a request to the host server 14. At 32, the host server 14 sends a command message to the user node 12 and also begins delivery of the requested content. Next, the user node 12 receives the command message and, in response, opens a second channel which is directed to the advertisement server 20. For a personal computer, this second channel is a second browser. At 34, the advertisement server transmits an advertisement in the second channel to the user node 12, and the user node 12 receives the advertisement at 35. After the advertisement has actually been received at the user node 12, the user node at 36 verifies receipt of the advertisement. The host server 14 receives this verification at 37 and can then confirm delivery and receipt of the advertisement.

The network 10 according to the invention therefore provides numerous advantages over conventional advertising on the Internet. For one, an advertisement server 20 can better trace the efficacy of an advertisement. The advertisement server 20 can, through the assistance of the host server 14, track the number of times that an advertisement potentially could have been delivered to the user node 12, the number of times that the advertisement was actually delivered to the user node 12, the number of times that the advertisement was actually received at the user node 12, and the portion of the advertisement that was actually viewed at user node 12. The network 10 according to the invention provides positive and direct proof that not only was an advertisement requested but that the advertisement was ultimately delivered to the user node 12. As will be described in more detail below, the verification provided by the user node 12 to the advertisement server 20 may also inform the advertisement server 20 of whether the entire advertisement was played, the extent to which the advertisement played, and any user input indicating that the user actually saw or interacted with the advertisement.

Another advantage of the network according to the invention is that the advertisement is delivered over a second channel. The advertisement may be provided in a banner ad or as part of the content from the host server 14, but preferably is delivered over the second channel separate from any content from the host server 14. Furthermore, as will become apparent from the description below, the second channel can be considered to provide the advertisement in an instant since the preferred advertisements fill in the gap between the time a user node 12 requests content from the host server 14 and when the entire content is delivered to the user node 12. During this gap, users of ten click on hyperlinks or stop the download because they are not willing to wait the entire length of time for the download from the host server 14. By providing the advertisement in this gap or time period, the user is distracted and preferably entertained and should lead to fewer click throughs or stopping.

Another advantage offered by the network 10 shown in FIG. 1 is the advertisements can be more intensive. The advertisements are preferably multi-media and have the appearance of many television commercials. The advertisements may include sound as well as moving images to attract the attention of the user.

II. Network Elements

The network 10 described above includes the host server 14, user node 12, and preferably the advertisement server 20 and the advertiser server 18. Preferred embodiments for each of the network elements will now be provided. It should be understood that these embodiments are merely examples of the preferred way of implementing the invention and the invention should not be construed to these particular examples.

A. User Node

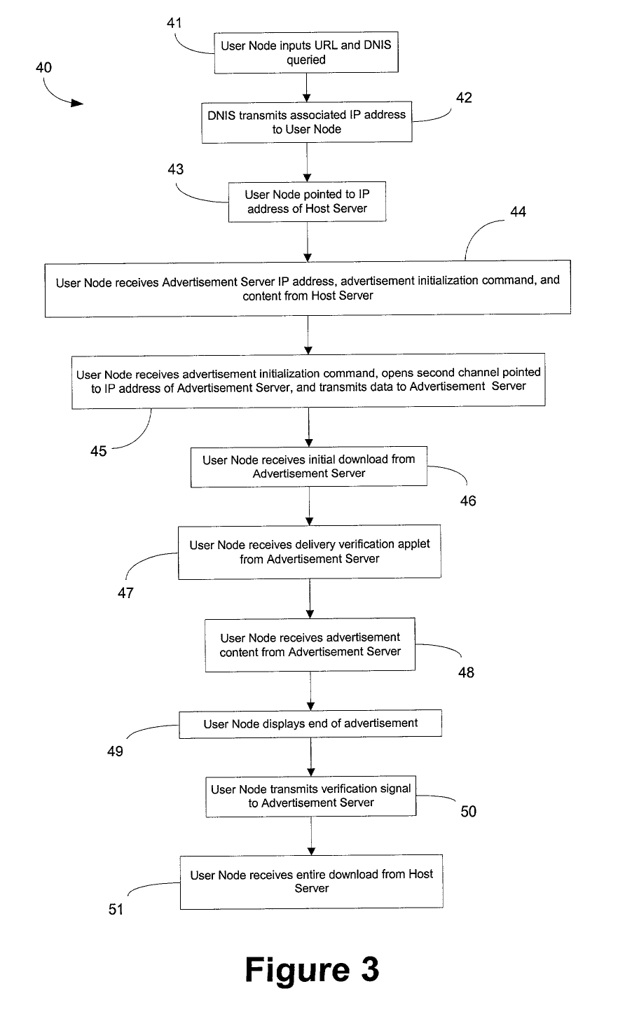

A preferred method at 40 that occurs at the user node 12 will now be described with reference to FIG. 3. At 41, the user node 12 inputs the URL for the host server 14 which results in the DNIS being queried. At 42, DNIS transmits the associated IP address for the host server 14 to the user node 12 whereby at 43, the user node 12 is pointed to the IP address of the host server 14. After being pointed to the host server 14, the user node at 44 receives the IP address for the advertisement server 20, the command message for opening the second channel, and also content from the host server 14. As discussed above, the content from the host server 14 is preferably provided in the original channel and the advertisement from the advertisement server 20 is inserted into the second channel. Thus, at 45, the user node 12 opens the second channel and points the second channel to the IP address of the advertisement server 20. Also at 45, the user node 12 transmits advertisement targeting data to the advertisement server 20. This advertisement targeting data identifies the user to the advertisement server 20 and also provides a profile for use in selecting an advertisement. At 46, the user node 12 receives an initial download from the advertisement server 20. This initial download is structured so that some portion of the advertisement is quickly displayed to the user, thereby filling in the downtime between a request from the host server 14 and the delivery of the requested information. After this initial download, the user node 12 receives a delivery verification applet from the advertisement server 20 at 47 and receives additional content for the advertisement from the advertisement server 20 at 48. The advertisement is advantageously displayed as it is being received at the user node 12 and consequently provides a “just in time” type delivery. The user node 12 therefore does not need to wait for the entire download from the advertisement server 20 before portions of the advertisement may be displayed. At 49, the user node 12 displays the end of the advertisement and, at 50, transmits the verification signal to the advertisement server 20. The verification signal may comprise a single signal that is transmitted at the end of the advertisement or may comprise a plurality of signals that are generated at various points while advertisement is played at user node 12. At 51, the user node 12 receives the entire download from the host server 14. The advertisement from the advertisement server 20 preferably fills in the gap between the request for content from the host server 14 and the completion of the delivery. In some situations, the advertisement may terminate after the download from the host server 14 has completed. Also, the advertisement may not completely fill the gap whereby the download from the host server 14 occurs some period of time after the advertisement has terminated.

B. Host Server

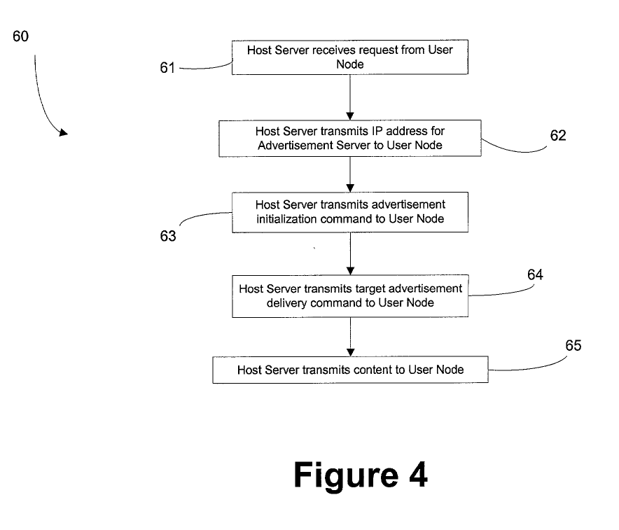

A preferred method 60 performed by the host server 14 will now be described with reference to FIG. 4. At 61, the host server 14 receives a request from the user node 12. In response to this request, the host server 14 at 62 transmits an advertisement initialization command. This command includes the IP address for the advertisement server 20 as shown in 62 and, as shown in 63, includes a second channel command for causing the user node 12 to open the second channel. The advertisement initialization command also includes a target advertisement delivery command which is sent to the user node 12. The target advertisement delivery command instructs the user node 12 to transmit data to the advertisement server 20 which allows the advertisement server 20 to identify the user and ascertain the profile for the user. The host server 14 also transmits the requested content, as shown in 65.

C. Advertisement Server

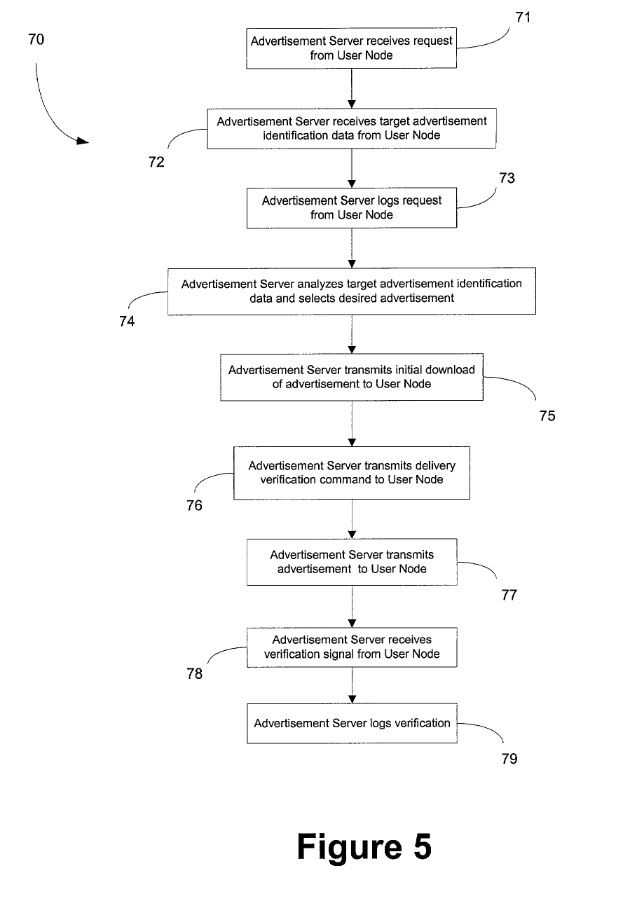

A preferred method 70 by which the advertiser server 18 communicates with the user node 12 will now be described with reference to FIG. 5. At 75, the advertisement server 20 receives a request from the user node 12. As discussed above, the host server 14 commands the user node 12 to contact the advertisement server 20 for an advertisement. The host server 14 preferably commands the user node 12 to transmit target advertisement identification data, which the advertisement server 20 receives at 72. This data preferably includes information to identify the user and also to profile the user. The data also includes an identification of the requested information from the host server 14, such as the URL that triggered the query to the advertisement server 20. At 73, the advertisement server 20 logs the request from the user node 12 and at 74 analyzes the target advertisement identification data to select a desired advertisement. The target advertisement identification data may include cookies or tracers that are placed on the user node 12 to assist the advertisement server 20 in selecting an advertisement that matches the user's profile. Various techniques and methods for selecting an advertisement are described in the Merriman patent and may be employed by the advertisement server 20. After an advertisement has been selected, the advertisement server 20 transmits an initial download of the advertisement to the user node 12. This initial download is structured so that a portion of the advertisement is quickly displayed at the user node 12. At 76, the advertisement server 20 transmits a delivery verification command to the user node 12. The delivery verification command preferably comprises a Java applet that allows the user node 12 to generate the verification signal. The invention includes other ways of enabling and/or generating a verification signal. At 77, the advertisement server 20 transmits the entire advertisement to the user node 12. In the preferred embodiment, the advertisement begins with the initial download at 75 and is delivered “just in time” so that the advertisement is being played at the user node 12 as later portions of the advertisement are being downloaded from the advertisement server 20. Furthermore, the entire advertisement is preferably structured so that it is quickly delivered from the advertisement server 20 to the user node 12 and is quickly played at the user node 12. After the advertisement has played, at 78 the advertisement server 20 receives the verification signal from the user node 12. As discussed above, the verification signal may be generated only once at the end of the advertisement or, alternatively, may be generated at multiple places throughout the advertisement. At 79, the advertisement server 20 logs the receipt of the verification signal from the user node 12. The information recorded at 79 by the advertisement server 20 can be used by the advertisement server 20 at 74 in selecting a desired advertisement. For instance, if an advertiser has a series of advertisements, the advertisement server 20 can determine the last advertisement delivered to the user node 12 and can select the next advertisement in the series.

D. Advertiser Server

The advertiser server 18 shown in FIG. 1 can access the advertisement server 20 to manage its advertising campaign. This connection between the advertiser server 18 and the advertisement server 20 may be through the Internet 16, or may be another type of connection, such as a dial-in connection. Furthermore, the advertiser server 18 may be on the same server as the advertisement server 20.

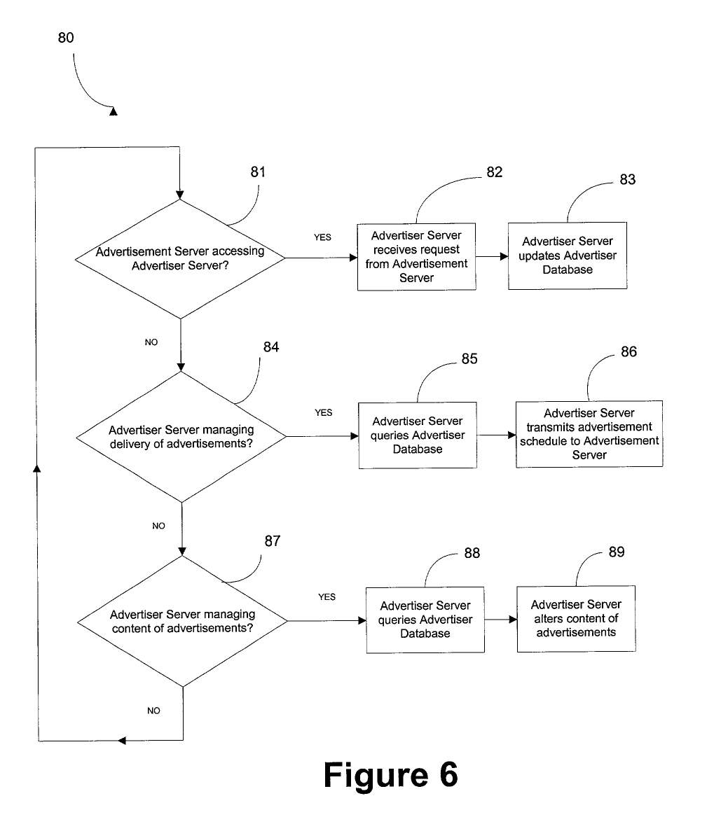

The advertiser server 18 can preferably access the advertisement server 20 to obtain information available at the advertisement server 20, to control the content that is being used for advertisements, or to manage the delivery of the advertisements to the users. A preferred example of such access is illustrated in FIG. 6. A method 80 of interfacing between the advertiser server 18 and the advertisement server 20 includes the ability for the advertisement server 20 to send data to the advertiser server 18. To access the data, the advertisement server 20 at 82 receives the request from the advertiser server 18 and at 83 the advertiser server 18 is allowed to input, output, query, or otherwise access information stored in the advertisement database within the advertisement server 20. On the other hand, if the advertiser server 18 wants to manage the delivery of advertisements, as determined at 84, then at 85 the advertiser server 18 queries the advertiser database and at 86 transmits a new advertisement schedule. The schedule may be based on a myriad of factors which influence when and how often and under what circumstances advertisements are to be shown to a particular user. The advertiser server 18 can also manage the content of the advertisements as shown at 87. At 88, the advertiser server 18 queries the advertiser database and at 89 alters the content of the advertisements. The advertiser server 18 may introduce new advertisements, modify existing advertisements, or delete advertisements.

III. Advertisement Server Topology

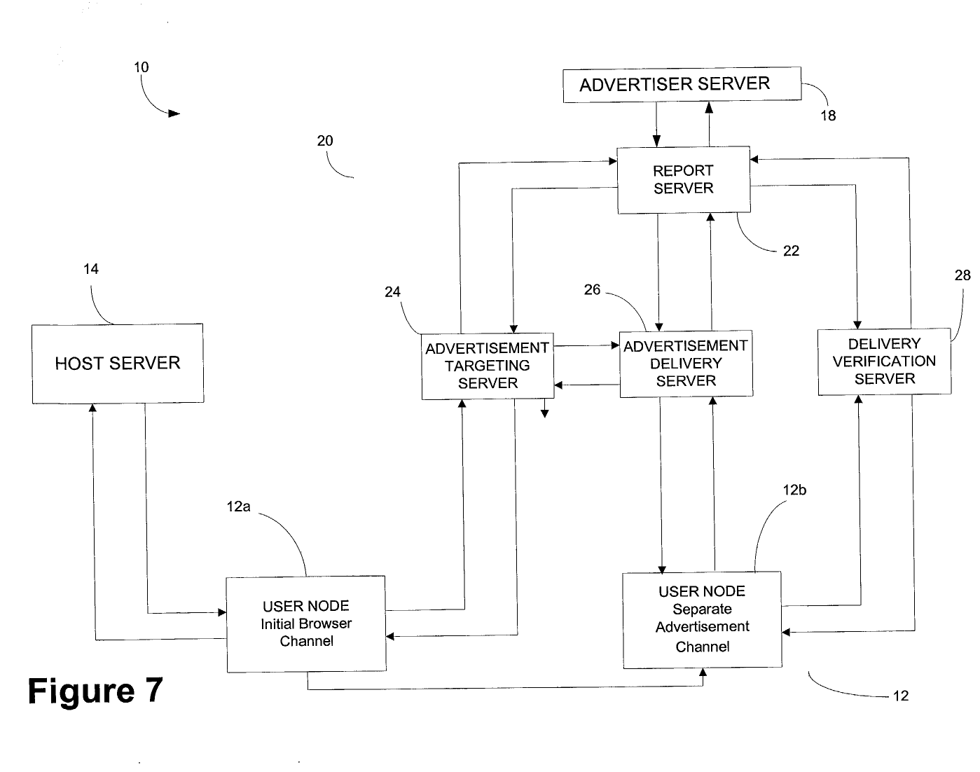

FIG. 7 illustrates the network 10 and shows a preferred diagram of the advertisement server 20. As shown in this Figure, the advertisement server 20 includes a report server 22, an advertising targeting server 24, an advertisement delivery server 26, and a delivery verification server 28. While these servers 22, 24, 26, and 28 are shown as separate items, the servers 22, 24, 26, and 28 may reside on the same computer, on multiple computers, may be located close proximity or remotely from each other, and may be operated by the same entity or by different entities.

During operation, the user node 12 contacts the host server 14 and, from the host server 14, receives the IP address for the advertisement server 20, the second channel command for opening up a second browser, and the target advertisement delivery command for causing the user node 12 to deliver target identification data to the advertisement server 20. As shown in FIG. 7, the user node 12 includes an initial browser or channel 12A for receiving the download from the host server 14 and a second channel or browser 12B for receiving the advertisement from the advertisement server 20. According to this example, the initial browser 12A receives the commands from the host server 14 to open up the second channel 12B and to transmit the target advertisement delivery data to the advertising targeting server 24.

The advertising targeting server 24 receives the identification data from the user node 12 and selects a desired advertisement to be delivered to the user node 12. A database is associated with the advertising targeting server 24 from which the advertising targeting server 24 can identify the user. The advertising targeting server database also contains information on advertisements, such as rotation schedule and intended audiences, from which the advertising targeting server 24 can select an advertisement that matches the user's profile.

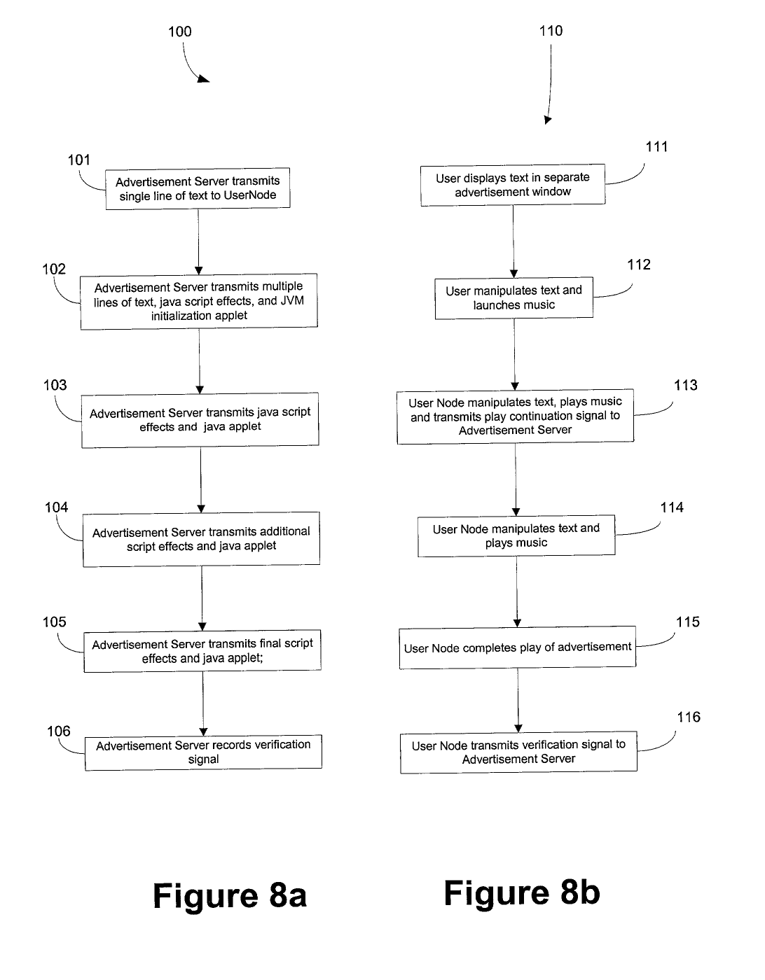

The advertisement delivery server 26 receives the desired advertisement from the advertising targeting server 24. The advertisement delivery server 26 may receive the actual advertisement or instead may receive some identification of the desired advertisement. In any event, the advertisement delivery server 26 delivers the desired advertisement to the user node 12 in the second channel 12B. The delivery of the advertisement will be described in more detail below with reference to FIGS. 8(A) and 8(B).

The delivery verification server 28 receives the verification signals from the user node 12. The user node 12 may deliver this verification signal at the end of the advertisement or periodically throughout the playing of the advertisement on the second channel 12B. The delivery verification server 28 maintains a log of which advertisements have been delivered and verified as being played to the user node, with this log being accessible by the advertising targeting server 24 in the selection of the next desired advertisement.

A report server 22 has access to the databases associated with the advertising targeting server 24, the advertisement delivery server 26, and the delivery verification server 28. By having access to all these databases, the report server 22 can perform various types of queries or data manipulations in order to provide useful information to the advertiser server 18. The report server 22 may also provide the interface to the advertiser server 18 which allows the advertiser server 18 to manage the delivery of the advertisements or the content of the advertisements.

IV. Advertisements

A preferred method 100 of transmitting an advertisement from the advertisement server 20 to the user node 12 will now be described with reference to FIG. 8A. A corresponding preferred method 110 of receiving and playing the advertisement at the user node 12 is shown in FIG. 8B. With reference to the method 100 of transmitting the advertisement, the advertisement server 20 at 101 transmits a single line of text to the user node 12. This single line of text is the initial download from the advertisement server 20 and is structured so that it is quickly downloaded and provides an “instant on” capability at the user node 12. At 102, the advertisement server 20 continues transmitting the advertisement by sending multiples of text, Java script effects, and a Java Virtual Machine (JAM) initialization applet. The advertisement server 20 at 102 transmits an empty applet to the user node 12 that starts the Java Virtual Machine (JVM). By launching this empty applet, the time delay normally associated with initializing the JVM is avoided, thereby providing a quicker delivery of the advertisement to the viewer.

At 103, 104, and 105, the advertisement server 20 transmits Java script effects and Java applets. The Java applets, effects, scripts, graphics, text, audio, and/or other information delivered to the user node 12 from the advertisement server 20 all effect the content of the advertisement. Consequently, the precise applets, effects, scripts, text, audio, graphics and other information will vary between advertisements. The invention is therefore not limited to the exemplary use of applets, Java scripts, effects, and audio.

The preferred method 110 for receiving and playing the advertisement begins at 111 with the user node 12 displaying the initial download of text in the second channel. At 112, the user node 12 manipulates the initial download and launches the audio file, which may be music. At 113 , 114, and 115 , the user node 12 continues to play the advertisement in accordance with the Java applets and scripts received from the advertisement server 20. The user node 12 completes the playing of the advertisement at 115 and then, at 116, transmits the verification signal to the advertisement server 20.

V. Example Of Advertisement

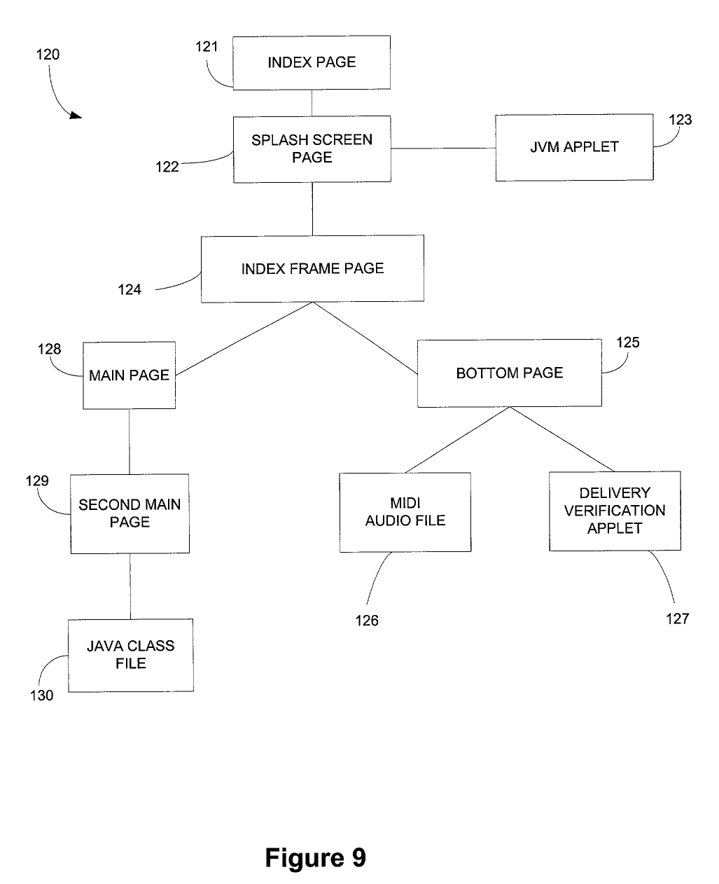

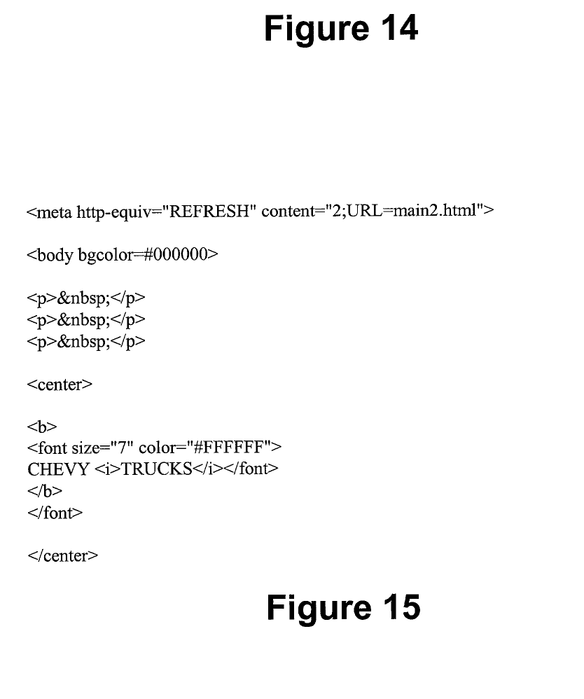

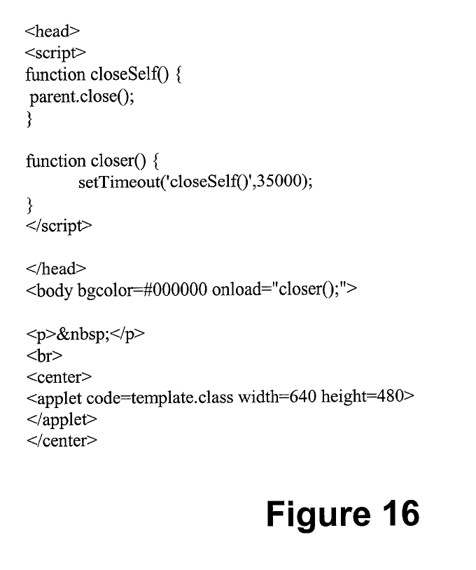

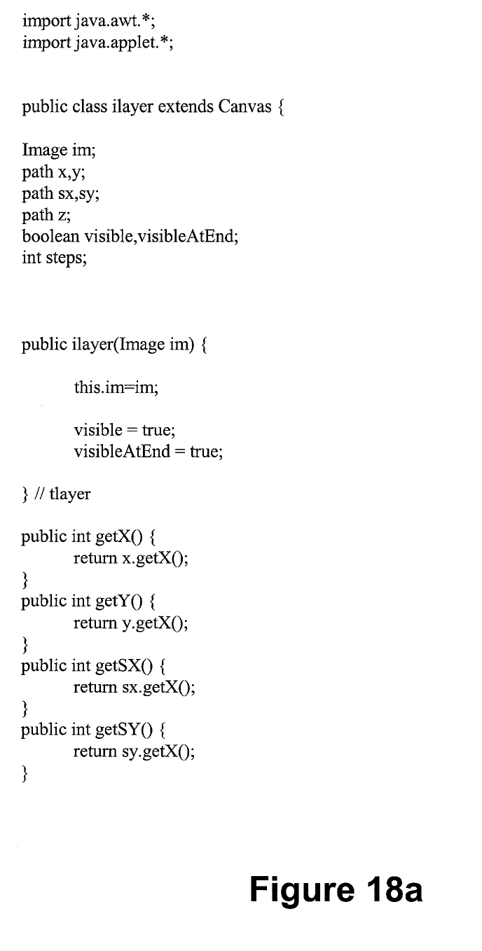

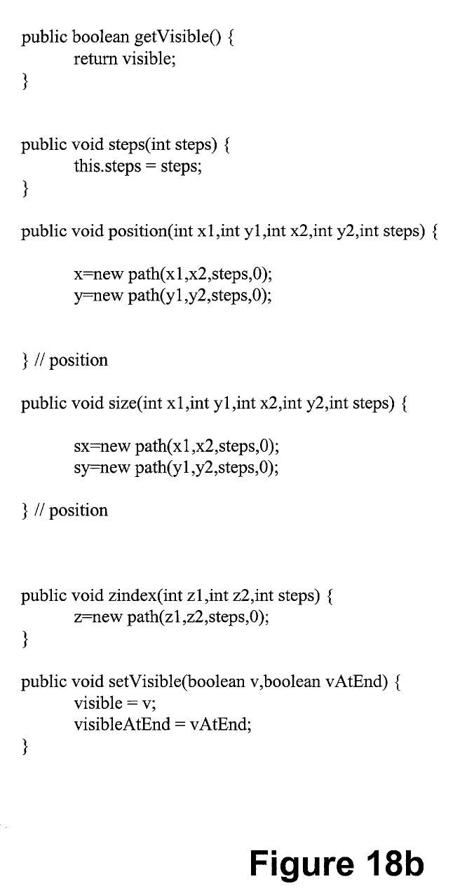

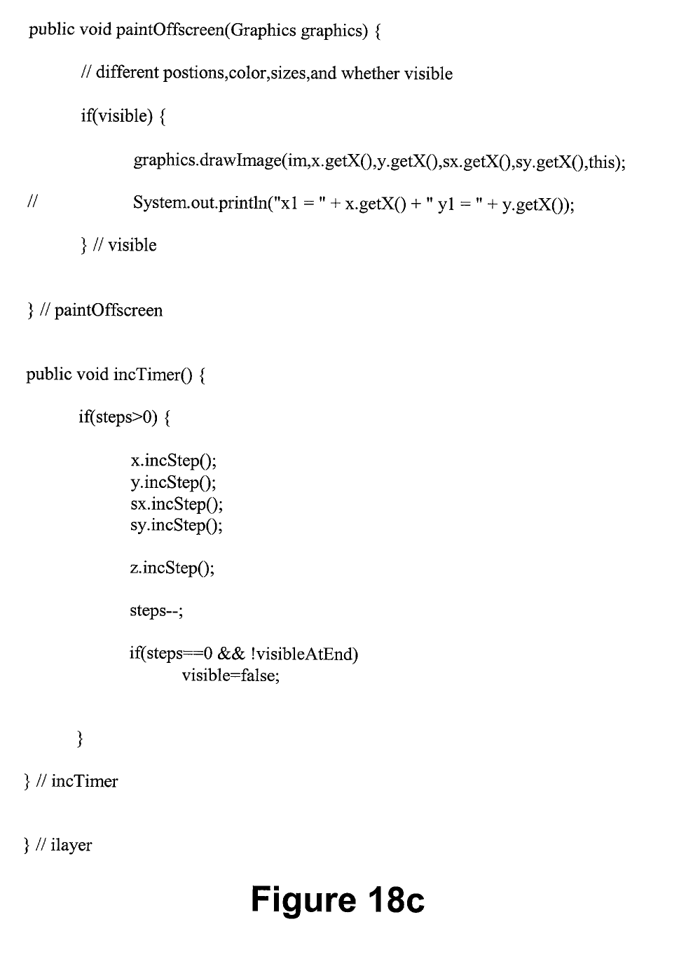

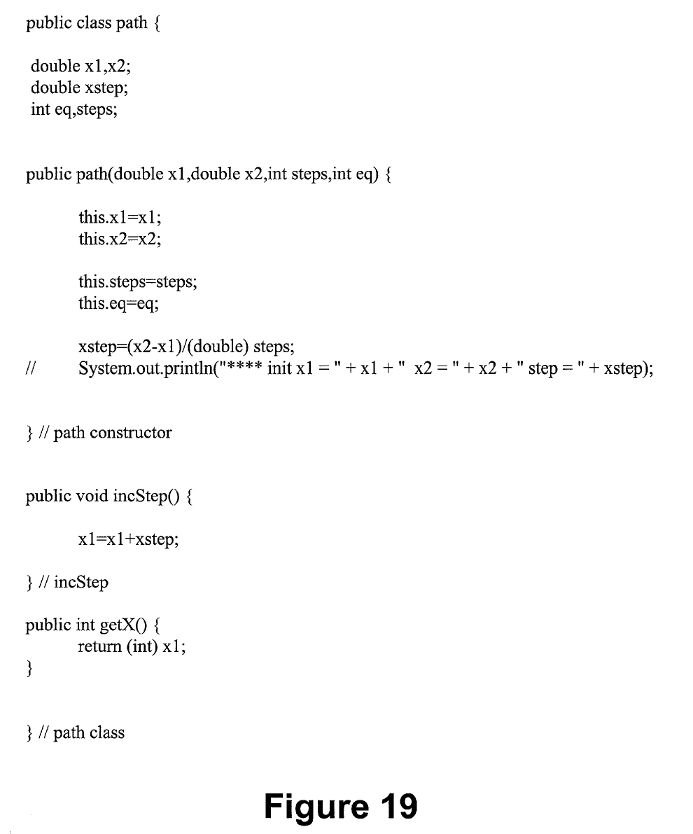

An example of a multi-media advertisement delivered over networks such as those illustrated in FIGS. 1 and 7 will now be described with reference to FIG. 9. It should be understood that the advertisement represented by FIGS. 9 to 20 is just one example and that an advertisement according to the invention may be structured differently, use different applets, different scripts, not use Java, and otherwise varied in ways apparent to those skilled in the art. The advertisements according to the invention will also be able to take advantage of advances in technology and is not limited to just what is presently known to those of skill in the art.

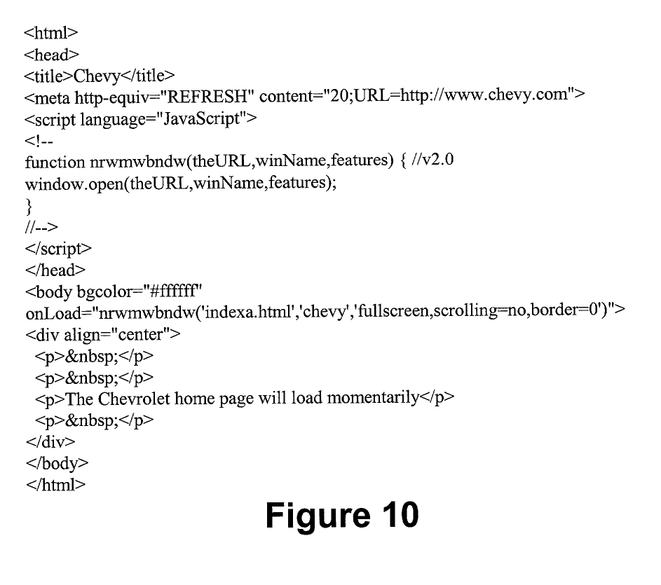

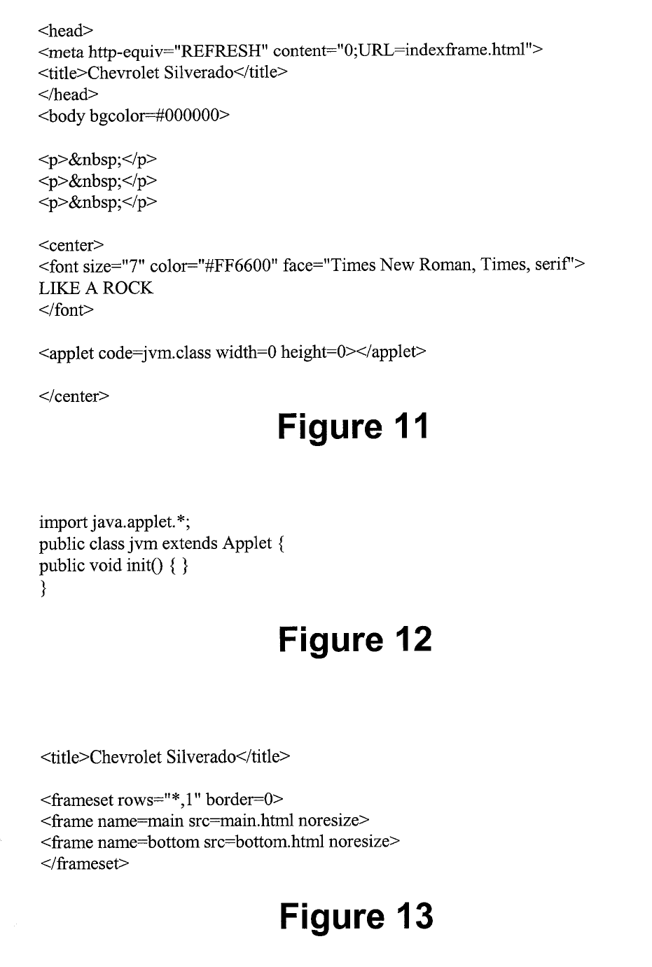

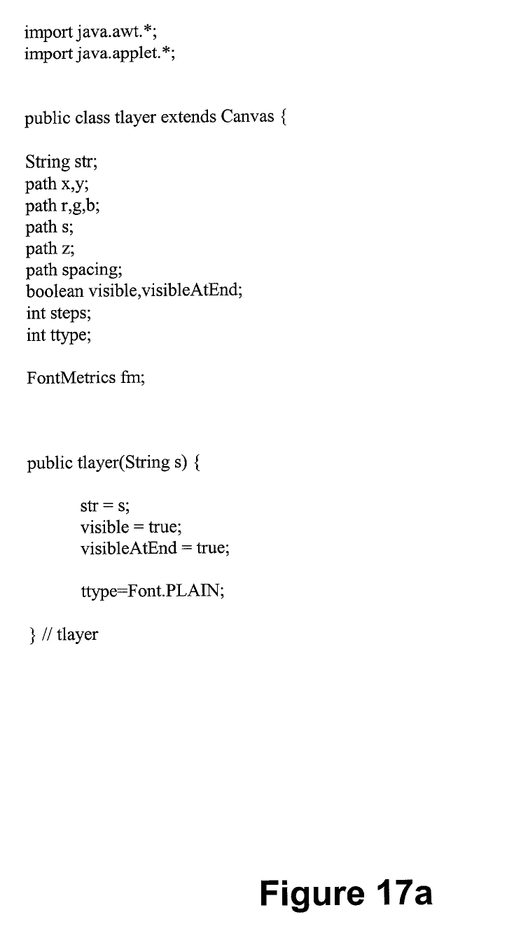

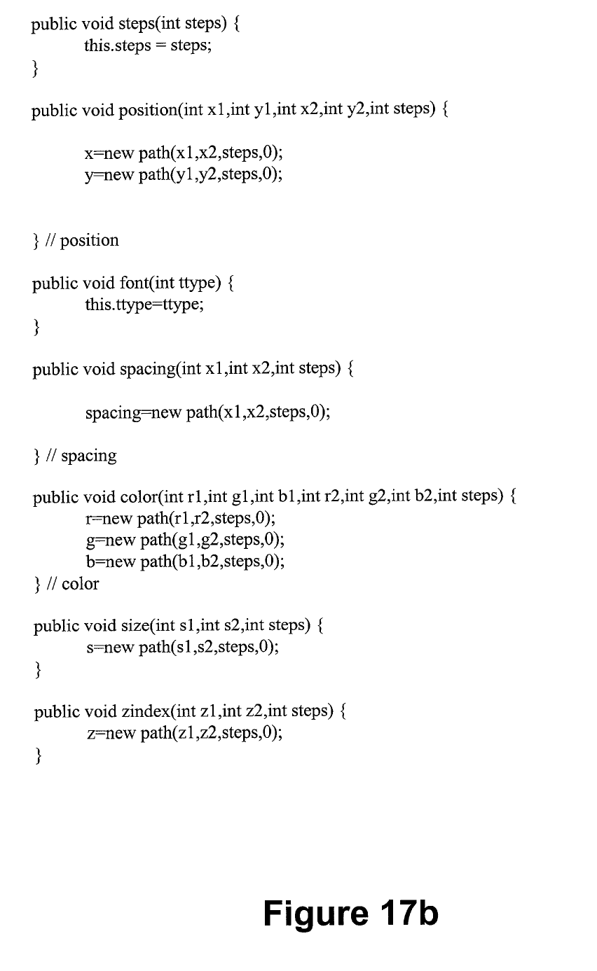

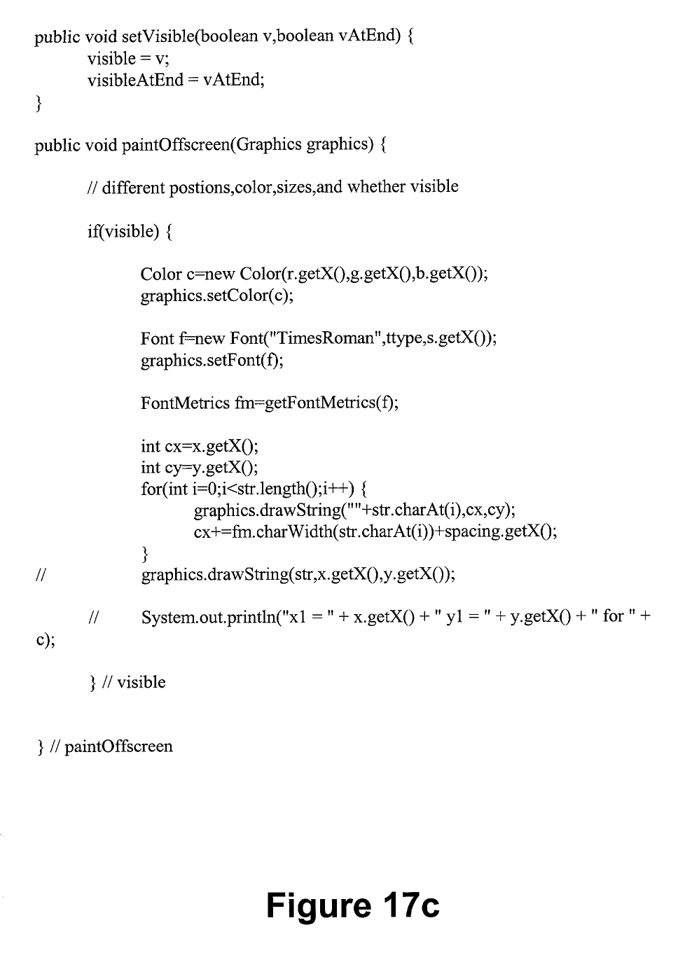

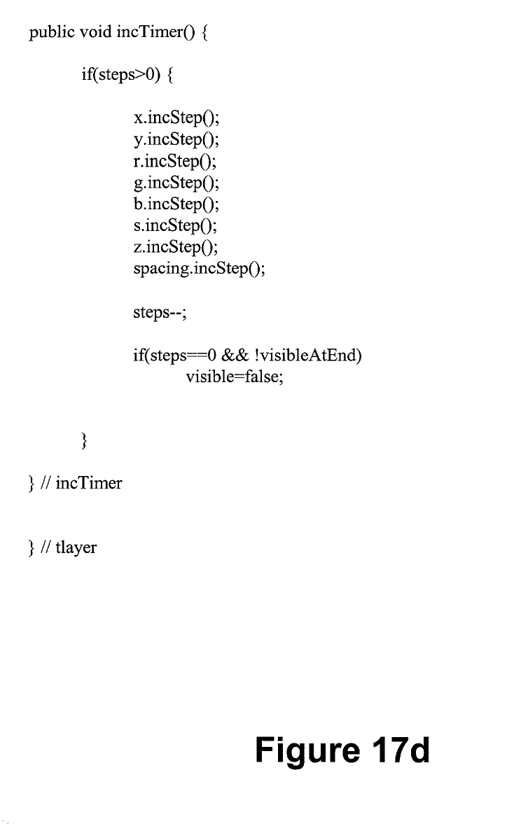

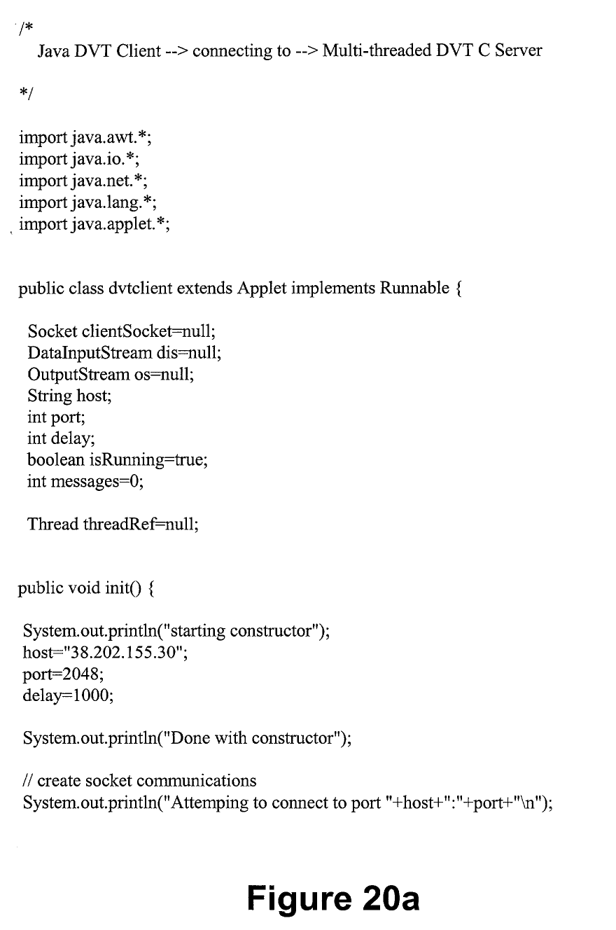

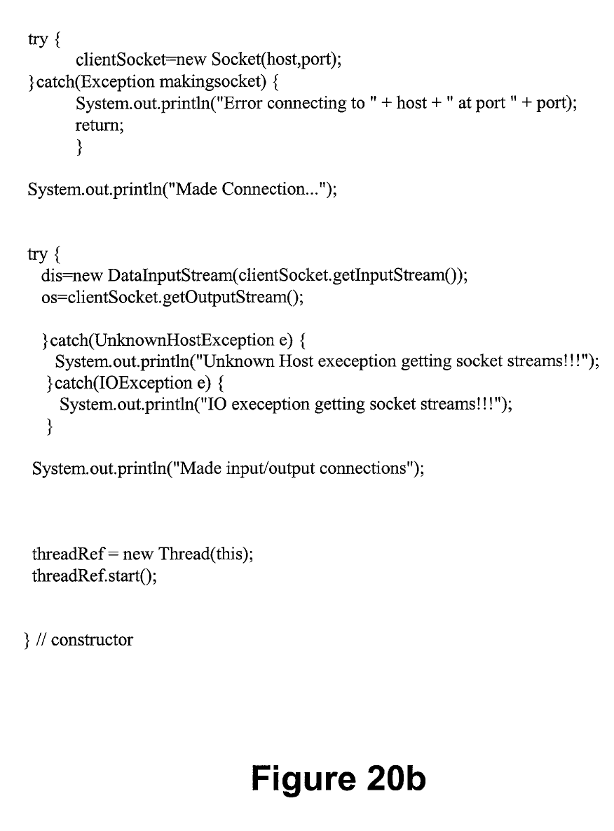

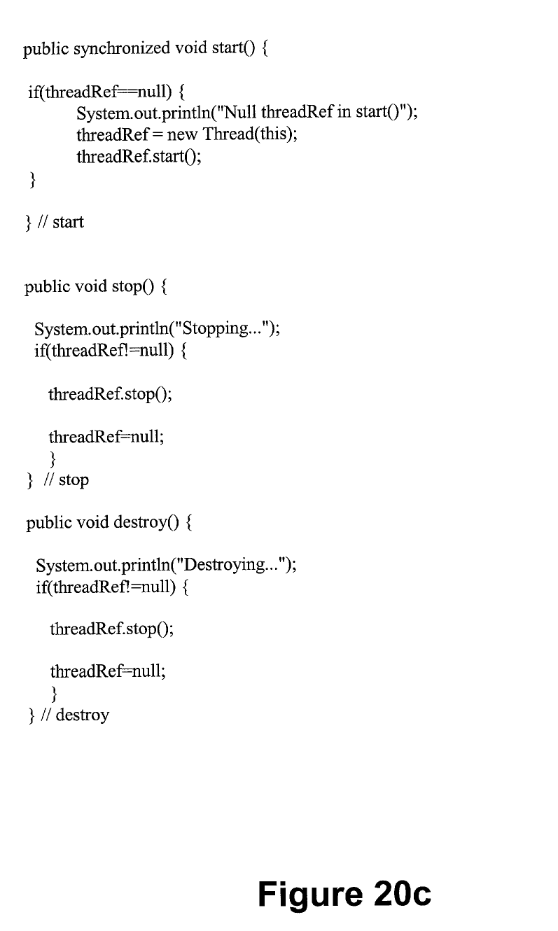

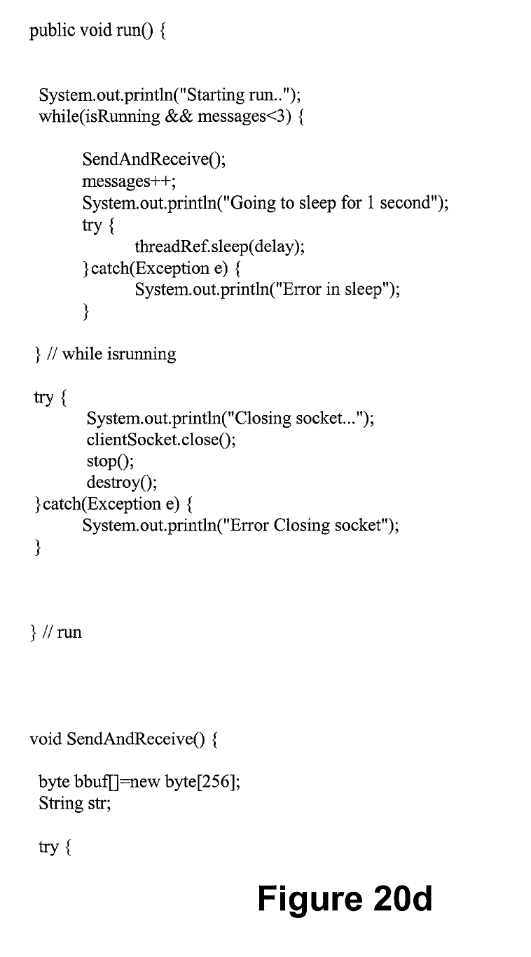

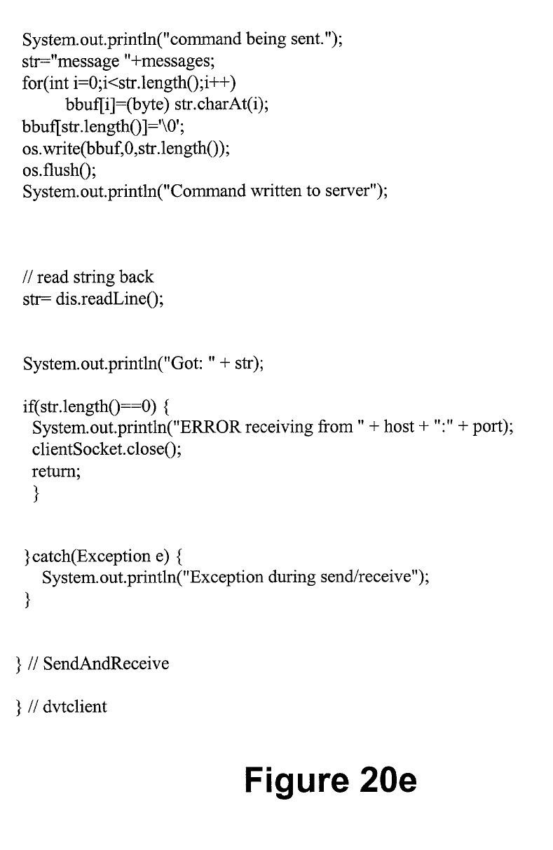

The multi-media Internet advertisement 120 includes a number of HTML pages and various Java scripts and applets. In FIG. 9, index page 121 is a web page viewed in the initial browser channel of user node 12 which initiates delivery of multi-media advertisement 120. FIG. 10 illustrates the HTML source for creating index page 121. Splash screen page 122 is the initial web page viewed in the separate advertisement channel of user node 12. Splash screen page 122 displays an initial text portion of multi-media advertisement 120, as well as initializes JVM applet 123. FIG. 11 illustrates the HTML source code for building splash screen page 122. JVM applet 123 launches the Java Virtual Machine, thereby limiting the time delay which results when JVM is not loaded before Java is actually required. FIG. 12 is the Java source code for JVM applet 123. Index frame page 124 is a second web page called by splash screen page 122 that builds the frames environment, as well as calls main page 128 and bottom page 125. FIGS. 13, 14, and 15 are the HTML source code for building pages 124, 125, and 128, respectively. Bottom page 125 is a third web page that initiates download of an audio file 126 and delivery verification applet 127. Audio file 126 may be a MIDI file or any other suitable audio file format. Delivery verification applet 127 controls transmission of verification signals from user node 12 to advertisement server 20. FIGS. 20a-20e are the Java source code for delivery verification applet 127. Main page 128 is a fourth web page that may be used for providing additional functionality. Second main page 129, shown in FIG. 17, is a fifth web page that loads Java class file 130, completes display of multi-media advertisement 120, closes the separate advertisement channel of user node 12, and signals the final verification signal to advertisement server 20. Java class file 130 is the actual code used to manipulate text and images and animate paths and layers, thereby providing an advertisement similar to a television commercial. FIGS. 17-19 are the Java source code for Java class file 130.

VI. Interactive

As discussed above, the user node 12 transmits a verification signal to the advertisement server 20 which signifies to the advertisement server 20 not only that the advertisement has been sent to the user node 12 but that the advertisement was played at the user node 12. The verification signal may be a single signal at the end of the advertisement or may be multiple signals to signify the incremental completion of playing the advertisement.

According to another embodiment, the advertisement is interactive and, in response to action by the user, the user node 12 transmits an action signal. The action signal is also transmitted to the advertisement server 20, such as the delivery verification server 28, or may be transmitted to a separate server, such as an action verification server. By providing interactive advertisements, the viewer is engaged more fully with the advertisement and allows for a more effective advertisement. In addition to the improved efficacy of the advertisement itself, the action verification signal provides additional information to the advertisement server 20. The delivery verification signal informs the advertisement server 20 that the advertisement reached the user node 12 while the action verification signal informs the advertisement server 20 that the viewer actually responded in some fashion to the advertisement.

VII. Alternative Method For Delivering Advertisements

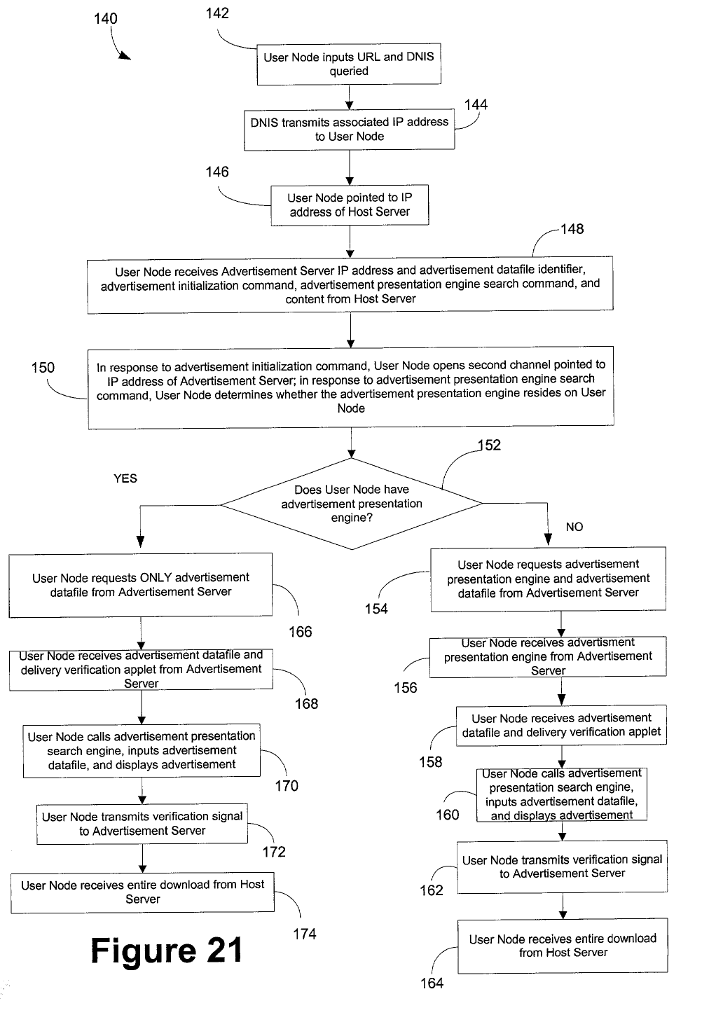

With reference to FIGS. 21-23, an alternative method of delivering advertisements over the network 10 will now be described. In the method of delivering advertisements discussed above, each time an advertisement is sent to the user node 12, the advertisement server 20 delivers all data required to present the advertisement, which may include, for example, text, images, audio, and all moving geometrical objects or vectors. In other words, all advertisement presentation functionality, whether or not the functionality is common to all advertisements, is included in each advertisement transmitted to the user node 12. In an alternative method of delivering advertisements, all common advertisement presentation functionality is included in an advertisement presentation engine residing on the user node 12 and all advertisement-specific functionality is included in an advertisement instructions datafile that is transmitted to the user node 12 by the advertisement server 20. By removing common functionality from the data payload and locating it on the user node 12, the advertisement server 20 may deliver longer and more complex advertisements that more resemble television commercials and may generate more revenue for advertisers, without a corresponding increase in needed bandwidth or download time.

The advertisement instruction datafile and the advertisement presentation engine may be adapted so that that the presentation engine can easily input the instruction datafile, run the advertisement-specific instructions, and display the resulting advertisement. For example, the advertisement presentation engine is preferably a Java applet having all the common advertisement presentation functionality and configured to accept instructions from a datafile of a known format. The data structure for the advertisement instructions datafile may include fields for text, images, Java scripts, and movement instructions or parameters for all vectors. In another embodiment, the instructions datafile may also include images and audio.

FIG. 21 shows an alternative method 140 that occurs at user node 12 for delivering advertisements over the network 10 in FIG. 1. At 142, 144, and 146, the user node 12 may access host server 14 in a manner similar to that described above with respect to method 40. After being pointed to the host server 14, the user node 12 at 148 receives the IP address for the advertisement server 20, the advertisement instructions datafile identifier, the command message for opening the second channel, the command message for searching the computer at user node 12 for the advertisement presentation engine, and also content from the host server 14. In a preferred embodiment, the advertisement instructions datafile identifier is encrypted by host server 14 to conceal the location and identity of the advertisement instructions datafile. As discussed above, the content from the host server 14 is preferably provided in the original channel and the advertisement from the advertisement server 20 is inserted into the second channel. Thus, at 150, the user node 12 opens the second channel, decrypts the advertisement instructions datafile identifier, and points the second channel to the IP address of the advertisement server 20.

Also at 150 and 152, the user node 12 performs a search to determine whether the advertisement presentation engine resides on the computer at the user node 12. If the computer at the user node 12 does not have the advertisement presentation engine, at 154, the user node 12 makes a request to advertisement server 20 to transmit the advertisement presentation engine and the advertisement instructions datafile. At 156 and 158, the user node 12 receives the advertisement presentation engine, and the advertisement instructions datafile. In the preferred embodiment, the advertisement server 20 decrypts the advertisement presentation engine and the advertisement instructions datafile. If the computer does have the advertisement presentation engine, at 166, the user node 12 makes a request to advertisement server 20 for only the advertisement instructions datafile. After receiving the download from the advertisement server 20, at 160 and 170, the user node 12 decrypts the download and calls the advertisement presentation engine to read the advertisement instructions datafile. Then, the advertisement presentation engine displays the advertisement at the user node 12. At 162 and 172, the user node 12 transmits the verification signal to the advertisement server 20. The verification signal may comprise a single signal that is transmitted at the end of the advertisement or may comprise a plurality of signals that are generated at various points while the advertisement is played at user node 12. At 164 and 174, the user node 12 receives the entire download from the host server 14.

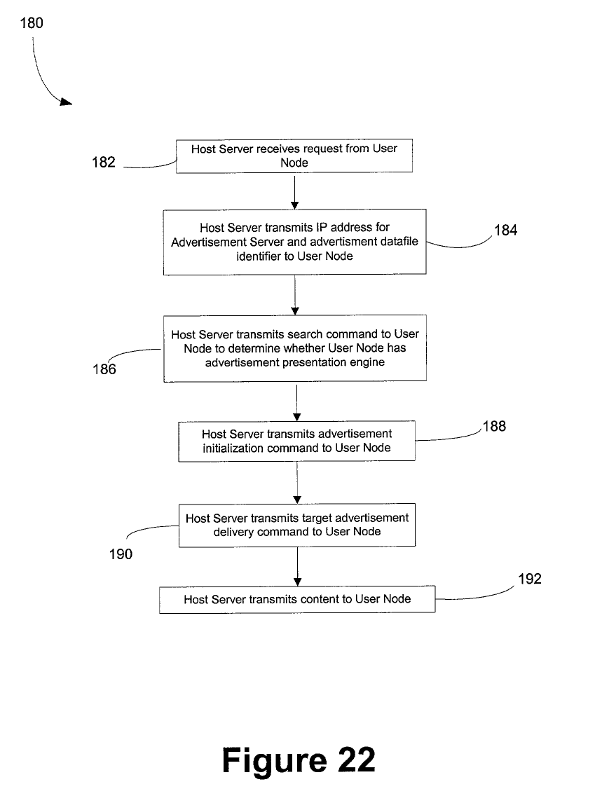

An alternative method 180 performed by the host server 14 will now be described with reference to FIG. 22. At 182, the host server 14 receives a request from the user node 12. In response to this request, the host server 14 at 184 transmits the IP address for advertisement server 20 and the advertisement instructions datafile identifier to the user node 12. At 186, the host server 14 transmits the search command to the user node 12, which is adapted to enable the user node 12 to determine whether the advertisement presentation engine resides on the computer at user node 12. At 188, the host server 14 transmits an advertisement initialization command, which is adapted to cause the user node 12 to open the second channel. At 190, the host server transmits target advertisement delivery command which is sent to the user node 12. The target advertisement delivery command instructs the user node 12 to transmit data to the advertisement server 20 which allows the advertisement server 20 to identify the user and ascertain the profile for the user. The host server 14 also transmits the requested content, as shown at 192.

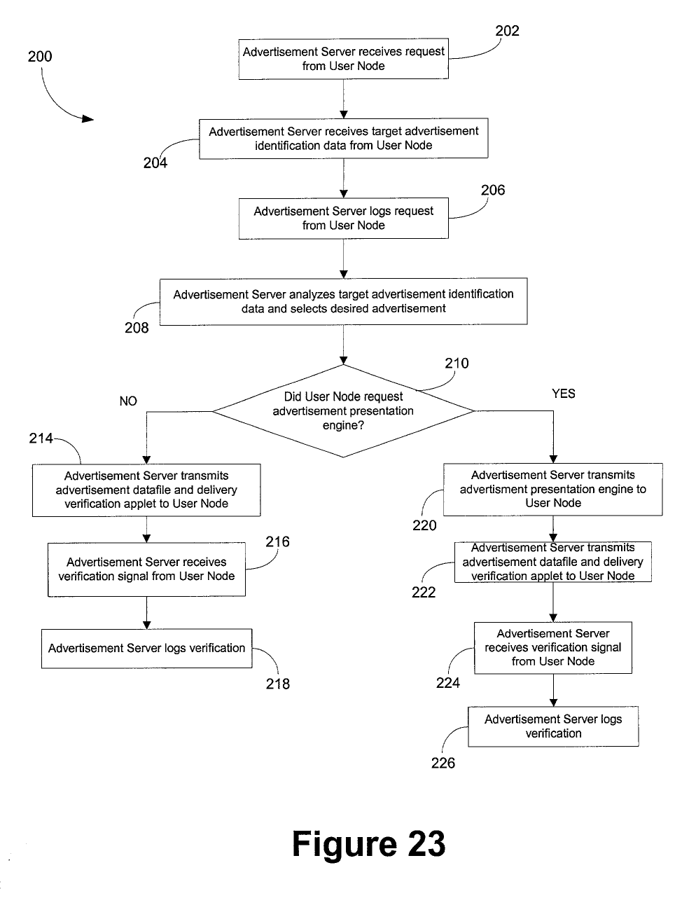

An alternative method 200 by which the advertisement server 20 communicates with the user node 12 will now be described with reference to FIG. 23. At 202, the advertisement server 20 receives a request from the user node 12. As discussed above with respect to method 70, at 204, 206 and 208, the advertisement server 20 receives targeting information, logs the request and selects the appropriate advertisement instructions datafile to transmit to user node 12. At 210, the advertisement server 20 determines whether or not the user node 12 requested the advertisement presentation engine. If the user node 12 requested the advertisement presentation engine, at 220, the advertisement server 20 transmits it to the user node 12. If the user node 12 already has the advertisement presentation engine, at 214, the advertisement server transmits only the advertisement instructions datafile to the user node 12. After the instructions datafile is transmitted, at 216 and 224, the advertisement server receives the verification signal from the user node 12. At 218 and 226, the advertisement server 20 logs the verification.

As discussed above, the advertisement presentation engine includes functionality that is common to multiple advertisements. The common functionality preferably includes the ability to display text and images and ways of manipulating the text and images. The common functionality may also include, but not necessarily, transmitting the verification signal or signals, playing audio, presenting video, as well as other functionality. While the advertisement presentation engine preferably includes as much common functionality as possible, it should be understood that a certain functionality may be omitted in order to reduce the size of the advertisement presentation engine and that omitted functionality may be provided in one or more other engines.

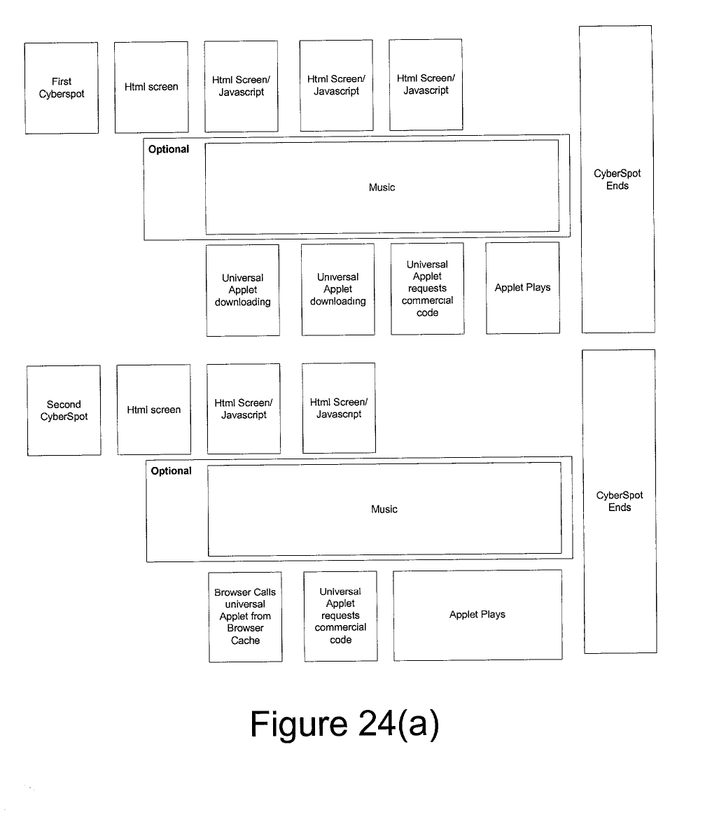

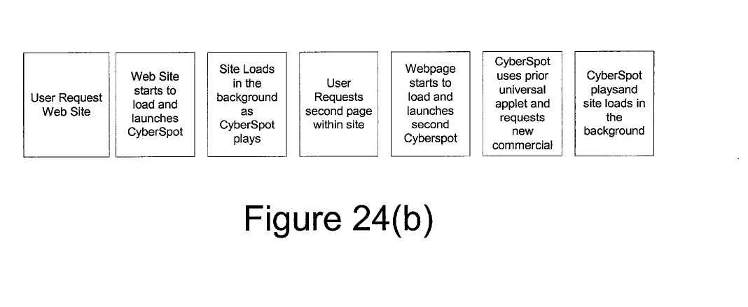

FIGS. 24a and 24b are examples of how the advertisement presentation engine and the instructions data file(s) can be delivered to a user node. In the example shown in FIG. 24a, a first Cyberspot begins with the user node receiving an html screen and some javascript. This initial download is designed to be quickly transferred to the user node for quick display. The actual size and contents of the download will vary with the connection speed and capabilities of the user node. The initial download may also include some music shown in conjunction with some of the html screens. During the time the user node plays the screens and music, the universal applet is being downloaded to the user node. Once the download is complete, the universal applet then requests the presentation instructions data file, such as commercial code. The universal applet then processes the instructions data file to play the presentation. For an advertisement, the presentation may include text, video, images, audio, etc. For the first Cyberspot, the user node advantageously is able to begin the presentation even though the universal applet and the data file have not been received. For the user, the user preferably is not able to detect any interruption in the presentation caused by downloading the presentation engine or the data file(s).

FIG. 24a also shows the playing of a second Cyberspot. This second Cyberspot may also include some initial download, such as html screens, html screen javascripts, and music which are designed to quickly provide the user node with some part of the presentation. Next, since the user node already has the presentation engine from the first Cyberspot, the user node need not download the presentation engine but instead the browser calls the universal applet from cache. The universal applet then requests the data file, such as second commercial code, and once that is received begins to process the instructions and content in the data file.

FIG. 24b depicts an example of a diagram from the viewpoint of the user. First, user sends a requests to a web site, such as the advertisement server or host server. In response to this request, the user node receives and launches the Cyberspot. As mentioned above, the Cyberspot plays while the user node downloads the rest of the Cyberspot. After this first Cyberspot, the user sends another request, either to the same web site as before or to a new web site. The user then receives another Cyberspot which begins to play while the instructions data file is being received. For this second Cyberspot, the user node need not receive any presentation engine.1

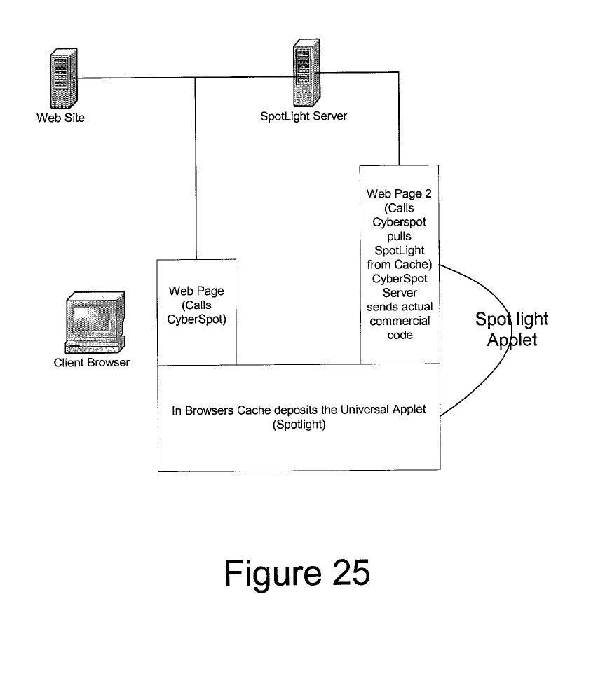

FIG. 25 illustrates a system diagram for delivering the first and second Cyberspots referenced in FIGS. 24a and 24b. As depicted in this diagram, the client browser, or user node, requests a web page and calls the first Cyberspot. In receiving the first Cyberspot, the client browser deposits the presentation engine in cache. When the client browser then requests a second web page, the second Cyberspot is called and the presentation engine, also called the universal applet or Spot light, is called from cache. Thus, for this second Cyberspot, the client browser only needs to receive the instructions data file, which is called the commercial code.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What we claim:

1. A method of providing presentations to a user node over the Internet, comprising:
providing a presentation instructions data file, the presentation instructions data file including content and instructions on presenting the content;
providing a presentation engine with functionality common to a plurality of different presentations, the functionality including at least functions of receiving the presentation instructions data file, running the instructions associated with the presentation instructions data file, and playing the presentation;
receiving a request from a user node for the presentation;
selecting the presentation from the plurality of different presentations;
determining if the user node has the presentation engine;
if the user node does not have the presentation engine, then:
delivering the presentation engine to the user node;
delivering the presentation instructions data file to the user node for the presentation;
if the user node has the presentation engine, then:
delivering the presentation instructions data file to the user node for the presentation;
wherein the presentation engine is delivered to the user node only if the user node does not have the presentation engine, whereby a total amount of data sent to the user can be reduced.

2. The method as set forth in claim 1, wherein the presentation engine comprises a Java applet.

3. The method as set forth in claim 1, wherein the presentation instructions data file comprises text.

4. The method as set forth in claim 1, wherein the presentation instructions data file comprises script.

5. The method as set forth in claim 1, wherein the presentation instructions data file comprises audio.

6. The method as set forth in claim 1, wherein the presentation instructions data file comprises video.

7. The method as set forth in claim 1, wherein the presentation instructions data file comprises images.

8. The method as set forth in claim 1, wherein delivering the presentation instructions data file comprises encrypting the presentation instructions data file.

9. The method as set forth in claim 1, wherein delivering the presentation instructions data file comprises delivering a single file.

10. The method as set forth in claim 1, wherein delivering the presentation instructions data file comprises delivering a plurality of files.

11. The method as set forth in claim 1, further comprising sending an initialization command for causing the user node to open a second channel to receive the presentation.

12. The method as set forth in claim 1, further comprising sending a delivery command for causing the user node to issue the request for the presentation.

13. The method as set forth in claim 1, further comprising determining information about the user node and selecting the presentation based on the user information.

14. The method as set forth in claim 1, wherein the presentation engine includes functionality for playing audio.

15. The method as set forth in claim 1, wherein the presentation engine includes functionality for playing video.

16. The method as set forth in claim 1, wherein the presentation engine includes functionality for verifying that the user node received the presentation.

17. The method as set forth in claim 1, wherein selecting the presentation comprises selecting the presentation based on the user node.

18. The method as set forth in claim 1, wherein selecting the presentation comprises selecting the presentation from a series of related presentations.
